(19) United States
(12) Patent Application Publication
(10) Pub. No.: US 2009/0189985 A1
(43) Pub. Date: Jul. 30, 2009

(54) IMAGE PROCESSING DEVICE FOR PROVIDING IMAGE QUALITY INFORMATION AND METHOD THEREOF

(76) Inventor: Yo Hwan NOH, Ansan-si (KR)

Correspondence Address: BIRCH STEWART KOLASCH & BIRCH, PO BOX 747, FALLS CHURCH, VA, 22040-0747, US

(21) Appl. No.: 12/352,780

(22) Filed: Jan. 13, 2009

(30) Foreign Application Priority Data
Jan. 28, 2008 (KR) 10-2008-0008778

(51) Int. Cl. H04N 17/00

(52) U.S. Cl. 348/175; 348/E17.002

(57) ABSTRACT

An image processing apparatus and method for providing image evaluation information is provided. The image processing apparatus includes: an encoder to encode an external image signal input from an image sensor to generate encoded image data; an evaluation unit to evaluate the image data based on analysis information associated with the external image signal to generate evaluation information; and an interface unit to externally transmit the evaluation information associated with the image data.

### CROSS-REFERENCE TO RELATED APPLICATION

This application claims the benefit of Korean Patent Application No. 10-2008-0008778, filed on Jan. 28, 2008, in the Korean Intellectual Property Office, the disclosure of which is incorporated herein by reference.

### BACKGROUND

1. Field of the Invention

The present invention relates to image processing, and more particularly, to an image processing device and method that may provide a user with a high quality of image data based on image evaluation information.

2. Description of the Related Art

Generally, an image processing device includes an image sensor and an image signal processor. The image signal processor receives, from the image sensor, an electrical signal, that is, raw data, corresponding to an external image to thereby generate encoded image data or YUV data corresponding to the electrical signal and to output the generated TV data or the image data.

The image processing device is installed in a portable device, enabling the portable device to function as a photographing device. Specifically, the image processing device may be provided in the portable device such as a cellular phone, a personal digital assistant (PDA), an MP3 player, and the like to thereby convert an external image to electrical data and to store the converted electrical data using various types of devices.

Generally, the image sensor may employ a charge coupled device (CCD) image sensor, a complementary metal-oxide semiconductor (CMOS) image sensor that is manufactured using a CMOS technology, and the like.

FIG. 1 is a block diagram illustrating a portable device including an image processing device according to a related art.

Referring to FIG. 1, the portable device including the image processing device may include an image sensor 101, an image signal processor ISP 103, a back-end chip 105, and a display unit 107. The portable device may further include a main chip to control general operations of the portable device, but descriptions related thereto will be omitted here.

The image sensor 101 may convert optical information to an electrical signal and thus may be a sensor that has a Bayer pattern. The image sensor 101 may output an electrical signal, that is, raw data, corresponding to an amount of light input via a lens.

The image signal processor 103 may convert the electrical signal, input from the image sensor 101, to a YUV value and provide the converted YUV value to the back-end chip 105. Also, the image signal processor 103 may encode data that is converted to the YUV value and thereby may provide the encoded data to the back-end chip 105.

The back-end chip 105 may transmit a control signal and the like to the image signal processor 103. Also, the back-end chip 105 may store, in a memory, image data that is input from the image signal processor 103, or may decode the input image data to thereby display the decoded image data on the display unit 107.

As described above, the conventional image processing device may process an image signal of an image, photographed by the image sensor 101, in real time and output the processed image signal to the back-end chip 105.

The back-end chip 105 may need to evaluate the image data that is input from the image signal processor 103 or to perform an error check for image processing. Also, since the back-end chip 105 may need to generate additional information such as a noise level, a focusing level, a brightness, a color expression, and the like in order to determine a screen quality, significant loads may occur.

When the image sensor processor 103 receives a capture command from the back-end chip 105, the image sensor processor 103 may provide three to four frames to the back-end chip 105 to select a stabilized frame from the provided frames and store the selected frame.

However, the above scheme may store image data that is obtained at the most stable timing, instead of storing the best quality of image data.

Here, the most stable timing may indicate that the image signal processor 103 stores photographed image data after the image signal processor 103 receives the capture command and then a predetermined period of time is elapsed.

Accordingly, even when image data is obtained at the most stable timing but, in this instance, a target is shaken or moved at this timing, the conventional image processing device may store the corresponding image data.

### SUMMARY

An aspect of the present invention provides an image processing device and method that may provide an image evaluation result, so that a user may select and store a high quality of image based on the provided image evaluation result, without causing serious loads in a back-end chip.

Another aspect of the present invention also provides an image processing device and method that may provide a user with various types of evaluation result values associated with image data according to a preset mode and thereby enable the user to select an image photographed according to a user preference.

Another aspect of the present invention also provides an image processing device and method that may provide an image evaluation result to make it possible to provide a user with various types of image evaluation information only by changing software of an existing back-end chip.

According to an aspect of the present invention, there is provided a device for processing image data, the device including: an encoder to encode an external image signal input from an image sensor to generate encoded image data; an evaluation unit to evaluate the image data based on analysis information associated with the external image signal to generate evaluation information; and an interface unit to externally transmit the evaluation information associated with the image data.

According to another aspect of the present invention, there is provided a method of processing image data, the method including: collecting analysis information associated with an external image signal that is input from an image sensor; evaluating image data based on the collected analysis information; and transmitting evaluation information associated with the image data to a back-end chip.

According to still another aspect of the present invention, there is provided a method of processing image data, the method including: transmitting a capture command to an image signal processor; receiving evaluation information associated with each of a plurality of image data from the image signal processor; and storing any one image data, among the plurality of image data, based on the received evaluation information.

In an aspect of the present invention, the evaluating may include: assigning a weight to each of factors constituting the collected analysis information; calculating a result value of the analysis information with the assigned weight; and determining an evaluation class according to the calculated result value.

Additional aspects, features, and/or advantages of the invention will be set forth in part in the description which follows and, in part, will be apparent from the description, or may be learned by practice of the invention,

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a portable device including an image processing device according to a related art,

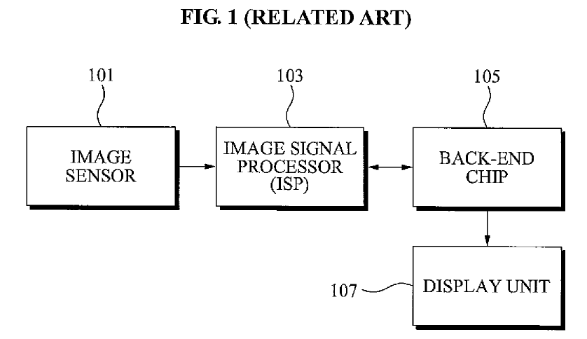

FIG. 2 is a block diagram illustrating a configuration of an image processing device providing an image evaluation result according to an embodiment of the present invention;

FIG. 3 is a flowchart illustrating an image processing method in an image processing device according to an embodiment of the present invention;

FIG. 4 is a flowchart illustrating an image evaluating method according to an embodiment of the present invention; and

FIG. 5 is a diagram illustrating an image processing process in an image processing device and a back-end chip according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, embodiments of the present invention will be described in detail with reference to the accompanying drawings, but they are not limited thereto or restricted thereby. When it is determined detailed description related to a related known function or configuration they make the purpose of the present invention unnecessarily ambiguous in describing the present invention, the detailed description will be omitted here. However, it will be readily understood by those skilled in the art from the following description.

A basic principle of the present invention is to evaluate each of a plurality of image frames that is received from an image sensor and provide an evaluation result to a back-end chip, when a capture command of image data is received, and thereby to enable a user to select image data to be stored based on the evaluation result or to store image data having the best evaluation result.

Hereinafter, embodiments according to the basic principle of the present invention will be described in detail with reference to the accompanying drawings.

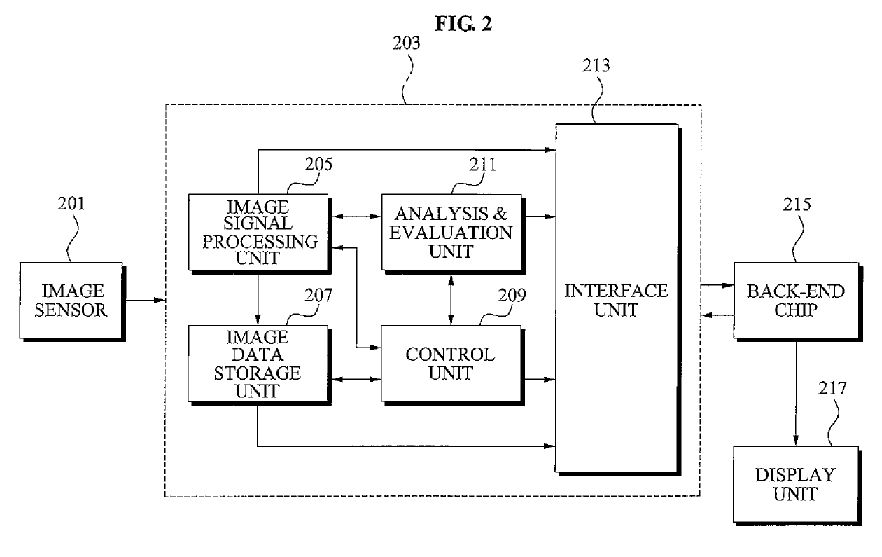

FIG. 2 is a block diagram illustrating a configuration of an image processing device providing an image evaluation result according to an embodiment of the present invention.

As shown in FIG. 2, the image processing device may include an image sensor 201 and an image signal processor 203. The image processing device may be connected to a back-end chip 215 installed in a portable device. The back-end chip 215 or a main chip (not shown) of the portable device may display an image provided from the image display device via a display unit 217.

The image sensor 201 may employ a charge coupled device (CCD) image sensor and a complementary metal-oxide semiconductor (CMOS) image sensor.

Referring to FIG. 2, the image signal processor 203 may include an image signal processing unit 205, an image data storage unit 207, a control unit 209, an analysis and evaluation unit 211, and an interface unit 213.

The image signal processing unit 205 may include a pre-processing unit (not shown) to receive, from the image sensor 201, raw data in a form of an electrical signal for each line and perform a pre-processing process for the received raw data, and an encoder to encode the pre-processed raw data.

Here, the above pre-processing may include a color space transform, filtering, color sampling, and the like.

Image data after the pre-processing process may be displayed via the display unit 217 in a preview mode corresponding to a state before a command is input from a user.

Here, the above encoding may denote JPEG format encoding that is performed after the user inputs a capture command, but the present invention is not limited thereto.

The image data encoded via the image signal processing unit 205 may be stored in the image data storage unit 207. Since the image data is stored in the image data storage unit 207 in a compressed form, it is possible to improve a message usage efficiency.

The image signal processing unit 205 may extract image analysis information associated with the image data through the pre-processing process and the encoding process. The analysis information may include a histogram, a sharpness, noise, an exposure, a brightness, a color balance, and the like

The analysis information is obtained through the pre-processing process of the image signal processing unit 205. The analysis information is not limited to the histogram, the sharpness, the noise, the exposure, the brightness, the color balance, and the like, and thus may include all the information that may be used to evaluate the image data.

The analysis and evaluation unit 211 may evaluate the image data by using image analysis information associated with the pre-processed image data as an evaluation factor.

The analysis and evaluation unit 211 may assign a predetermined weight to the analysis information to thereby evaluate the image data.

The control unit 209 may control general operations of the image sensor 201 and the image signal processor 203, and receive a preview command, a capture command, and the like from the back-end chip 215 to control the image signal processor 203 to perform a corresponding operation.

The control unit 209 may generate a predetermined clock to control an operation time of each of constituent elements that construct the image signal processor 203.

The interface unit 213 may communicate with an internal device or an external device of the image processing device.

The interface unit 213 may include either a serial peripheral interface (SPI) or I2C (inter-IC), or may include both the SPI and the I2C.

The SPI may be an interface that enables data exchange between two peripheral devices using a serial communication. In this instance, one peripheral device may function as a master device and another peripheral device may function as a slave device. The SPI may operate in a full duplex scheme, which may indicate that data may be bi-directionally transmitted at the same time. Although the SPI is generally employed for a system that performs a communication between a central processing unit (CPU) and peripheral devices, two microprocessors may be connected in an SPI form.

The I2C, also referred to as Inter-IC, may be a bi-directional serial bus that provides a communication link between integrated circuits (ICs). The I2C bus may include three data transmission modes according to a speed such as a standard mode, a high speed mode, and a very high speed mode. The I2C bus may support 100 Kbps in the standard mode, support 400 Kbps in the high speed mode, and support maximum 3.4 Mbps in the very high speed mode. All the three modes may have a lower compatibility. The I2C bus may support equipments having a 7-bit address space and a 10-bit address space and may also support equipments operating at different voltages.

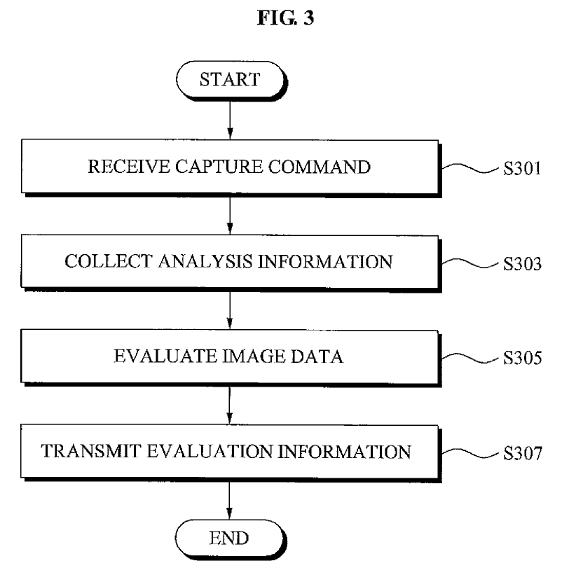

FIG. 3 is a flowchart illustrating an image processing method in an image processing device according to an embodiment of the present invention. The image processing device may be constructed as shown in FIG. 2.

The image processing method may include: operation S301 of receiving a capture command from the back-end chip 215 in a preview mode; operation S303 of collecting analysis information associated with an external image signal that is input from the image sensor 201; operation S305 of evaluating image data based on the collected analysis information; and operation S307 of transmitting evaluation information associated with the image data to the back-end chip 215. Here, the image data may be three to four frames corresponding to the capture command.

Referring to FIG. 3, when the capture command is received from the back-end chip 215 in operation S301, the control unit 209 may control the image signal processing unit 205 and the analysis and evaluation unit 211 to operate.

The image signal processing unit 205 may encode input data, for example, three to four frames according to a control signal of the control unit 209.

In operation S303, the analysis and evaluation unit 211 may collect analysis information associated with the image data from the image signal processing unit 205.

Here, the analysis information associated with the image data may be collected and stored after encoding for a single frame is completed.

In operation S305, the analysis and evaluation unit 211 may evaluate the image data based on the collected analysis information to thereby generate valuation information associated with the image data.

When the evaluation is performed for a plurality of frames, the analysis and evaluation unit 211 may generate priority order information that is in a descending order of a class or evaluation value of evaluation information associated with each frame.

In operation S307, the interface unit 213 may transmit the evaluation information to the back-end chip 215. The interface unit 213 may transmit the evaluation information to the back-end chip 215 via a data transmission port for transmitting the image data. Also, the interface unit 213 may transmit the priority order information to the back-end chip 215 via a communication port. Through this, a data transmission may be quickly performed.

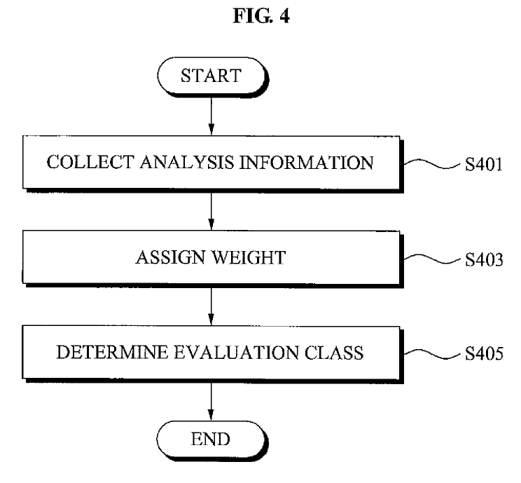

FIG. 4 is a flowchart illustrating an image evaluating method according to an embodiment of the present invention. The image evaluating method may be performed by the analysis and evaluation unit 211 of FIG. 2.

Referring to FIG. 4, the image evaluating method may include: operation S401 of collecting analysis information; operation S403 of assigning a weight to each of factors constituting the collected analysis information to calculate a result value of the analysis information with the assigned weight; and operation S405 of determining an evaluation class according to the calculated result value.

In operation S401, after a capture command is received from a user, the analysis and evaluation unit 211 may receive analysis information associated with image data from the image signal processing unit 205.

The analysis information may include at least one of a histogram, a sharpness, noise, an exposure, a brightness, and a color balance.

As described above, the analysis information may be obtained from a pre-processing process. The analysis information is not limited to the histogram, the sharpness, the noise, the exposure, the brightness, the color balance, and the like, and thus may include all the information that may be used to evaluate the image data.

In operation S403, the analysis and evaluation unit 211 may assign the weight to each of the factors constituting the analysis information. Here, a sum of weights assigned to the factors may be set to be “1”. Also, the weight may be variously determined according to a user selection or a setting mode.

For example, in a mode set for emphasizing the exposure and the color balance, a relatively greater weight may be assigned to an exposure factor and a color balance factor and a relative smaller weight may be assigned to the remaining factors.

Also, in the user selection or the setting mode, at least two references may be set. In this case, at least two image data may be selected as data with a relatively excellent evaluation result according to the at least two references.

In operation S405, the evaluation and evaluation unit 211 may calculate the result value of the analysis information with the assigned weight to determine a class of the image data based on a predetermined threshold. Specifically, when the evaluation value is greater than or equal to the threshold, for example, a first threshold, a high quality class may be assigned. Conversely, when the evaluation value is less than or equal to the threshold, a low quality class may be assigned.

The analysis and evaluation unit 211 may generate priority order information with respect to image data having the evaluation value greater than or equal to the threshold. The analysis and evaluation unit 211 may enable a user to select the best quality of image data based on the priority order information.

According to another embodiment of the present invention, the analysis and evaluation unit 211 may not select a frame with an inferior photographed state by determining an over-exposure, excessive noise, and the like with respect to image data of which an evaluation value is greater than or equal to a predetermined threshold, for example, a second threshold.

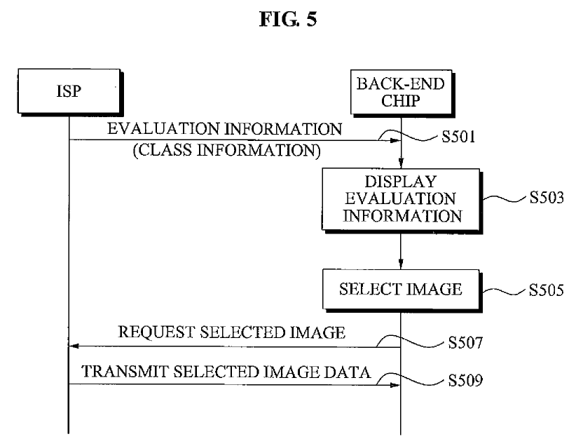

FIG. 5 is a flowchart illustrating an image processing process in an image processing device and a back-end chip according to an embodiment of the present invention.

The image processing method may include: transmitting a capture command to an image signal processor ISP; receiving evaluation information associated with each of a plurality of image data from the image signal processor; and storing any one image data, among the plurality of image data, based on the received evaluation information.

Referring to FIG. 5, after transmitting a capture command to the image signal processor, the back-end chip may receive evaluation information associated with each of a plurality of image data from the image signal processor in operation S501.

In operation S503, the back-end chip may display the received evaluation information to help a user selection. Here, the evaluation information may be displayed using various types of schemes. For example, the evaluation information may be provided together with an image, or only the evaluation information may be displayed in a descending order.

Also, a plurality of images may be simultaneously displayed together with the evaluation information for a user verification or a user selection. The displayed image may be an image that is provided in a preview mode, or a thumb nail image.

When the user selects an image corresponding to the evaluation information in operation S505, the back-end chip may request the image signal processor to transmit the selected image in operation S507.

According to another embodiment of the present invention, a back-end chip may receive, from an image signal processor, evaluation information associated with image data and encoded image data, and store the received evaluation information and the encoded image data. In this case, a user may immediately store selected image data.

In operation S509, when the image signal processor maintains the encoded image data, the image signal processor may transmit the selected image data, that is, the encoded image data to the back-end chip in response to the transmission request.

As described above, according to embodiments of the present invention, an image signal processor may evaluate image data immediately after image processing is performed for a single frame and may transmit an evaluation result to a back-end chip.

Also, according to embodiments of the present invention, a back-end chip may receive, from an image signal processor, any one image data that is selected by a user based on an evaluation value, instead of receiving a plurality of high-capacity image data, that is, encoded image data by a capture command.

Also, according to embodiments of the present invention, a back-end chip may significantly reduce loads in image processing.

Also, according to embodiments of the present invention, it is possible to overcome the structural limit in a conventional image processing device to thereby enable a user to capture and store more accurate and high quality of image.

Also, according to embodiments of the present invention, a user may select and store more high quality of image without causing serious loads in a back-end chip.

Also, according to embodiments of the present invention, it is possible to provide a user with various types of image evaluation information by only changing software of an existing back-end chip.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A device for processing image data, the device comprising:
an encoder to encode an external image signal input from an image sensor to generate encoded image data;
an evaluation unit to evaluate the image data based on analysis information associated with the external image signal to generate evaluation information; and
an interface unit to externally transmit the evaluation information associated with the image data.

2. The device of claim 1, further comprising:
a storage unit to store the encoded image data.

3. The device of claim 2, wherein, when a plurality of image data is stored in the storage unit, any one image data is selected from the plurality of image data based on the evaluation information and the selected image data is externally transmitted via the interface unit.

4. The device of claim 1, wherein the evaluation unit evaluates the image data based on at least one of a histogram, a sharpness, noise, an exposure, a brightness, and a color balance that are comprised in the analysis information associated with the external image signal.

5. The device of claim 4, wherein the evaluation unit assigns a predetermined weight to each of factors constituting the analysis information to evaluate the image data.

6. A method of processing image data, the method comprising.
collecting analysis information associated with an external image signal that is input from an image sensor,
evaluating image data based on the collected analysis information; and
transmitting evaluation information associated with the image data to a back-end chip.

7. The method of claim 6, wherein the evaluating comprises.
assigning a weight to each of factors constituting the collected analysis information;
calculating a result value of the analysis information with the assigned weight; and
determining an evaluation class according to the calculated result value.

8. The method of claim 7, wherein the weight is determined based on preset mode information.

9. A method of processing image data, the method comprising,
transmitting a capture command to an image signal processor;
receiving evaluation information associated with each of a plurality of image data from the image signal processor; and
storing any one image data, among the plurality of image data, based on the received evaluation information.

10. The method of claim 9, wherein the storing comprises displaying the evaluation information associated with each of the plurality of image data and, when any one evaluation information is selected from the plurality of displayed evaluation information, storing image data corresponding to the selected evaluation information.

11. The method of claim 9, wherein the received evaluation information is acquired by collecting analysis information associated with an external image signal input from an image sensor and by evaluating the image data based on the collected analysis information.
